(19) United States
(12) Patent Application Publication
(10) Pub. No.: US 2010/0004792 A1
(43) Pub. Date: Jan. 7, 2010

(54) ACQUISITION, CONTROL AND MEASUREMENT DEVICE

(75) Inventors: Jose Luis Polina Lopez, Gomez Palacio (MX); Alberto Acosta Gomez, Torreon (MX); Fernando Berumen Escalera, JR., Durango (MX); Milton Rivera Carrillo, Torreon (MX); Norma Aguilar Bueno, Torreon (MX)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: SENSA CONTROL DIGITAL, S.A. DE C.V., Torreon (MX)

(21) Appl. No.: 12/173,241

(22) Filed: Jul. 15, 2008

(30) Foreign Application Priority Data
Jul. 4, 2008 (MX) MX/A/2008/008749

(51) Int. Cl. G06F 1/30; G06F 1/28

(52) U.S. Cl. 700/292; 700/286

(57) ABSTRACT

An Acquisition, Control and Measurement device has the capability to operate as element in an Electrical Distribution of Average Tension Network or in an Electrical Substation, operating as master device (initiates the communication) or slave (responds the communication) in SCADA (Supervisory Control and Data Acquisition) systems. The device can process logical states and analogical signals, and has the capability to handle digital outputs using relay contacts and optoisolated digital inputs. The device can be used to simultaneously interconnect control equipment into diverse systems of acquisition through communication ports and standard communication protocols. Remote devices can access a data base using any means available. The device can be used as a data concentrator and/or protocol translator and includes a virtual connection of the transparent port type for communication towards other devices that manage software without data conversion through the communication ports.

### BACKGROUND OF THE INVENTION

Until the Acquisition, Control and Measurement Device of the present invention, the market for Automation of Electrical Distribution Networks included integrated equipment with apparatuses or modules of different brands to provide the functions of opening and closing of the relay of the Electrical Network and to take readings from parameters of flow measurement and alternate voltage. These apparatuses were limited in their functionality, maintenance and expansion.

### OBJECT OF THE INVENTION

With the present invention, we extend the capabilities of standard automatism of the elements of the Electrical Distribution Networks. Besides providing the standard functions, the present invention has the possibility of operating up to four disconnecting switches including all its measurement parameters; it counts or operates with capabilities such as measurement of the energy quality and the possibility to operate in an autonomous way in the presence of a contingency in the Electrical Network, with its logical functions of automatism denominated CVT.

Also because of its reduced size and ease of configuration, the present invention facilitates maintenance by the equipment user personnel. All of the above places the invention at the vanguard of the technology in the field of Automation of Electrical Distribution Networks.

The present invention provides a device that has the capacity to operate as an Acquisition, Control and Measurement element in the Electrical Distribution of Average Tension Network or in an Electrical Substation, operating as master device (initiates the communication) or slave (responds the communication) in the SCADA systems (Supervisory Control and Data Acquisition).

The device of the present invention is able to process logical states and analogical signals, such as electric flow and voltage parameters, frequency and power. It also has the capability to manage digital outputs by means of relay contacts and optoisolated digital inputs.

The device of the present invention has connectivity capabilities and data handling that allow it to be used to simultaneously interconnect control equipment to several systems of Acquisition through its communication ports and standard communication protocols such as DNP and Harris 5000/6000.

The device of the present invention allows remote devices to access their data base through links including TCP/IP, RS-232, RS-485, Modem GPRS, Modem FSK or using any available means, such as radio, telephone, audio, cellular, Internet, Intranet or cable.

The device of the present invention has the possibility of handling SCADA protocols, and serving as a concentrator of data and/or translator of protocols. It also includes a virtual connection of the transparent port type for communication with other devices that manage solely Proprietary Software, without conversion of the data, through any of its communication ports.

For its configuration and maintenance, the device of the present invention has a serial communication port RS232/RS485 with data transfer capacity from 300 to 115200 baud that can be configurable by means of software.

In order to assure operation continuity, the device of the present invention includes two 127 VAC supply inputs that operate to provide redundancy, thereby maintaining operation of the device in the absence of either supply input. Additionally, it has a battery pack that goes into operation in the total absence of the 127 VAC supply. It also counts with or includes alarms to alert in a remote way, by means of communication protocol, the absence of VAC or a low level in the battery pack.

The device of the present invention is modular and versatile equipment since it can be compared with its basic elements, while also providing the possibility of expansion or function growth by only adding modules of Firmware (embedded software) and adding the corresponding hardware modules within the interconnection connectors available for this purpose, without the need to use cables.

The device of the present invention also counts with or includes a configuration and maintenance software, that performs its function through a visual interface in a Windows environment, compatible with Windows 98/2000/XP, thereby providing the user with ample facilities to handle and comprehend the required information to configure and to provide maintenance to the device, and thereby reducing costs in time of training and setting up of the equipment.

The device of the present invention incorporates functionalities used for measurement of energy quality, such measurement being related to the measurement of electrical disturbances such as overtones or interruptions of voltage that can affect the provision of electrical conditions or damage the involved equipment in the electrical network. This feature provides the device an exponential capacity of use.

The device of the present invention has the capability to detect an overload fault of current in the line of average tension and to immediately send an alarm to the Master Central Unit that is monitoring it, so that the delivered information is analyzed and the necessary actions are taken to isolate and restore the failed path of the circuit of the Electrical Network remotely operating the involved disconnecting switches.

The device of the present invention has the capability to carry out automatism of auto sectionalization in the distribution Networks of average Tension by means of logics of operation denominated Control Voltage Time (CVT) and special hardware, exclusively based in the detection of voltages both from the source side and the charge side, in such a manner that in the presence of a contingency or failure within a ringed circuit, achieves isolation of the failed path, reestablishes the operational sections located between the source and the failed path, and recovers the later operational sections to the section failed through a liaison element towards another circuit of the Electrical Distribution of Average Tension Network.

### BRIEF DESCRIPTION OF THE FIGURES

An embodiment of the invention will now be described together with the drawings attached drawings in which:

FIG. 1 is an image of a totally assembled Processing and Communications Module, shown as a real representation of the module.

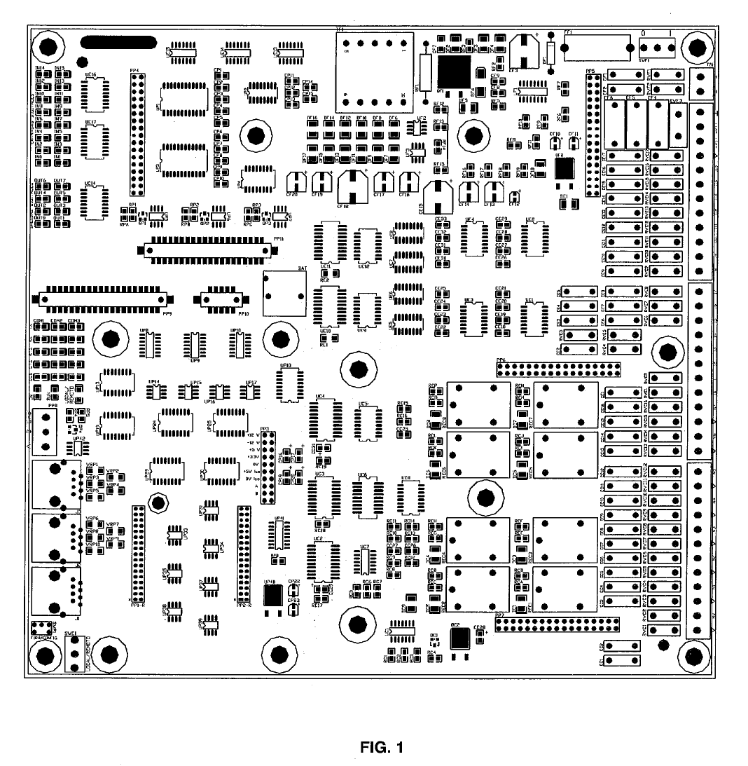

FIG. 2 is an image of a totally assembled Analogical Processing Module, shown as a real representation of the module.

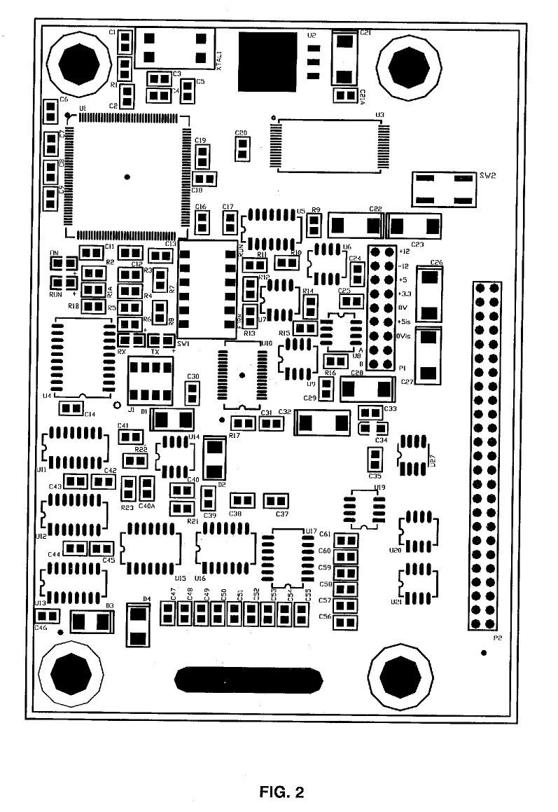

FIG. 3 is an image of an assembled Charge Source Module, shown as a real representation of the module.

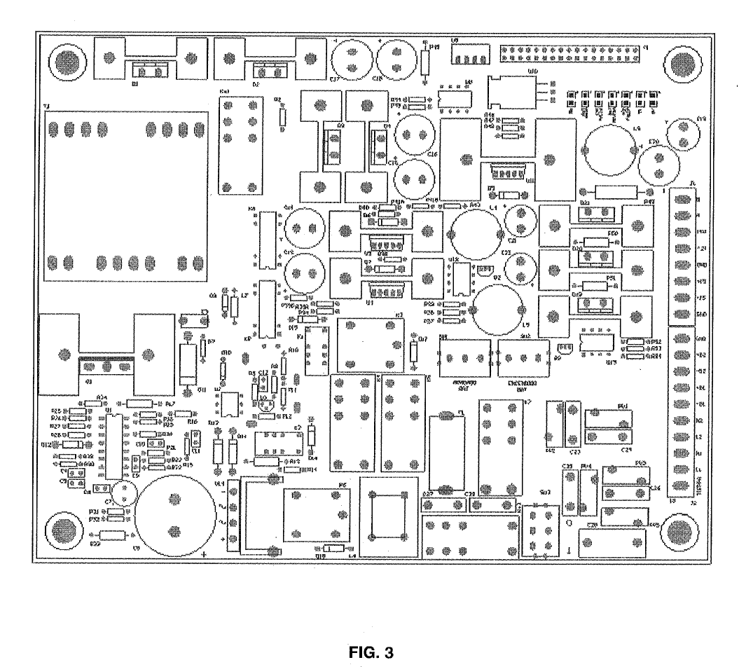

FIG. 4 is an image of an assembled Analogical Preparation Module, shown as a real representation of the module.

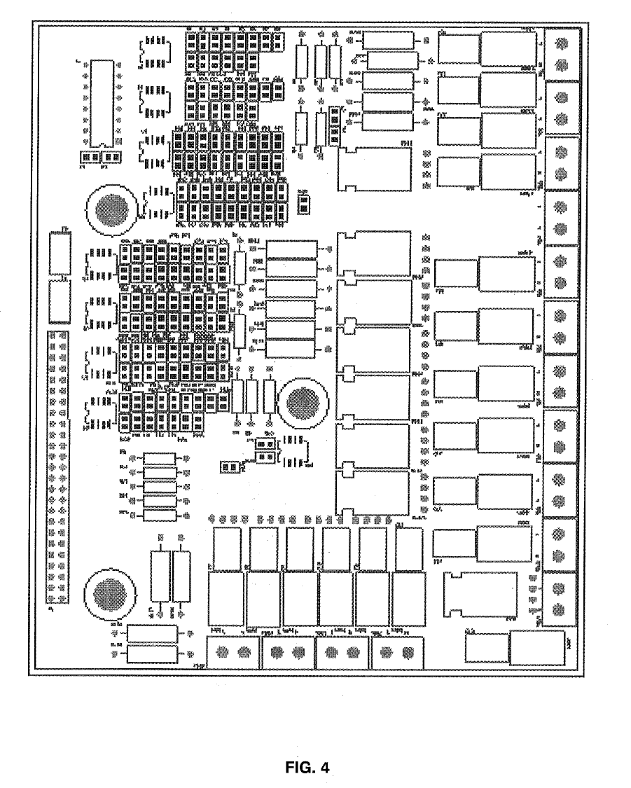

FIG. 5 is an image of an assembled optional Expansion of Controls Module, shown as a real representation of the module.

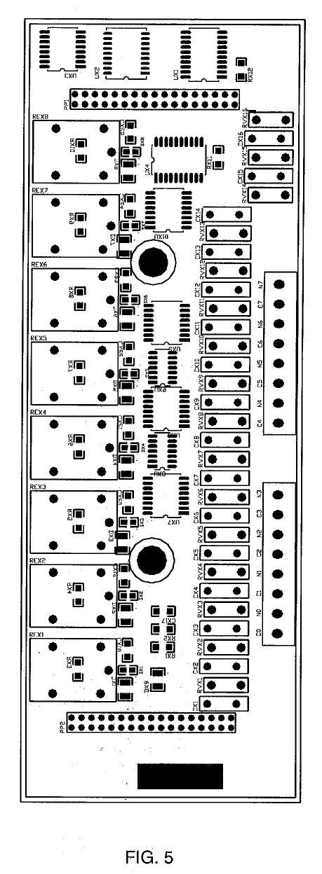

FIG. 6 is an image of an assembled optional Local Control Panel, shown as a real representation of the module.

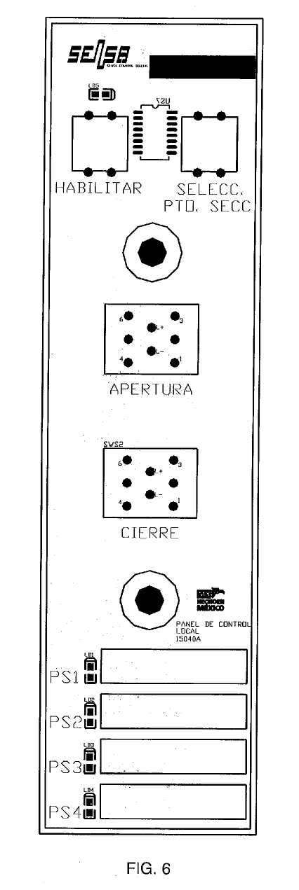

FIG. 7 is an image of an Acquisition, Control and Measurement Device integrated and assembled, shown as a real representation of the device.

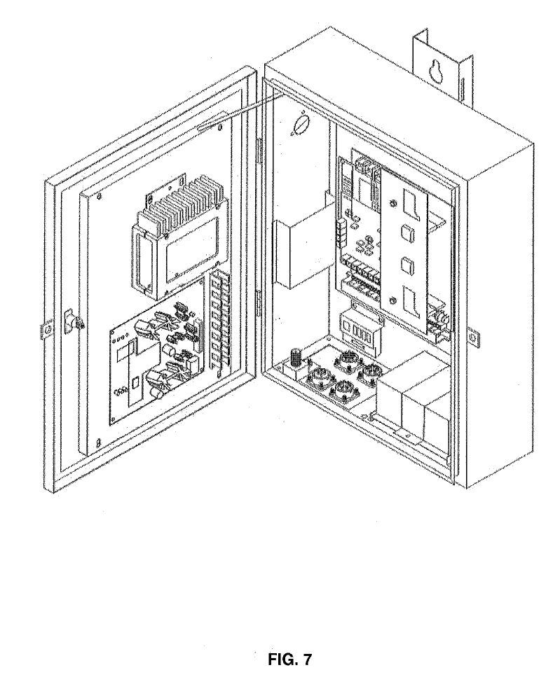

FIG. 8 is an exploded view of an assembled Acquisition Control and Measurement Device of the present invention.

FIG. 9 is an interconnection diagram of an Acquisition and Control Device including a radio for data communication, its antenna and accessories.

### DETAILED DESCRIPTION OF THE PREFERRED EMBODIMENTS

Following the elements that integrate the Acquisition, Control and Measurement Device of the present invention, in its basic configuration, equipment options and firmware that are managed for its growth will be described.

The basic equipment includes the following:

Hardware:
1. Processing and Communications Module
   1.1. Rank of feeding of 12 to 32 VDC
   1.2. Sixteen (16) optoisolated digital entrances, with protection against reverse polarity
   1.3. LEDs to visualize the status of each one of the digital inputs
   1.4. Eight (8) simple digital outputs or four (4) digital double outputs TRIP/CLOSE with option of growth to eight (8) by means of an optional expansion module with momentary contacts normally opened with capacity of 10 Amp @ 28VDC, 10 Amp @ 120 VAC or 5 Amp @ 240 VAC
   1.5. Local or Remote operation Selector
   1.6. LEDs to visualize the status of each one of the digital outputs
   1.7. Two serials ports for data communication configurable by software such as RS232 or RS485
   1.8. A serial port for maintenance configurable by software such as RS232 or RS485
   1.9. A serial port RS485 for communication with peripheral modules
   1.10. Two Bus of internal parallel Data for devices interconnection for data communication routed by MODEM FSK, modem GPRS or Ethernet 10/100/100 Base-T TCP/IP
   1.11. Three Bus of internal parallel Data for the connection of expansion modules and base modules
2. Analogical Processing Module
   2.1. Processing Capacity of up to fifteen (15) analogical inputs of voltage or current or a mix of both by means of DSP (Digital Signal Processor)
   2.2 ADC Converter of 13 bits+sign
   2.3. Serial communication RS485
3. Analogical Preparation Module
   3.1. Conditioning of up to fifteen (15) analog channels, that can be configured in plant according to the requirement like fifteen (15) inputs of AC voltage or twelve (12) inputs of AC current or a combination of both
   3.2. The AC voltage inputs can accept levels of 120 V, 10 V or 7.5 AC (configured in factory), have 1 MOhm of input impedance, support measurement of voltage overload of up to 2.5 times the nominal and over tension without causing damage to a 200% of the nominal in a continuous way, has an Absolute exactitude to Nominal Value of 0.2%
   3.3. The AC inputs of current can accept levels of 1 Amp or 5 Amps (configured in factory), support current overload measurements up to 2.5 times the nominal and of current overload without causing damage of 400% of the nominal non continuous having a 1% exactitude
4. Charge Source Module
   4.1. Two supply inputs of 127 VAC (Volts of Alternating current) that operate one like a back up of the other, with an operation rank from 90 to 140 VAC.
   4.2. A voltage output of 15 VDC (Volts of Direct Current) at 3 constant Amperes
   4.3. A voltage output of 24 VDC (Volts of Direct Current) at 10 non constant Amperes
   4.4. Periodic programmable function for periodic batteries self test
   4.5. Report of alarms
   4.6. Report of analogical measurements of voltage and output current
5. Battery Pack
   5.1. Battery Pack of 24 VDC formed by 2 Batteries 12VDC 5 Amp/hr each one
   5.2. Provides: 8 Hrs of back up in “standby”; 6 hrs. with 2 SCADA interrogations per minute; 4 hrs. with 2 SCADA interrogations per minute and a operation cycle open-close-open of a disconnecting switch at the end; or 2 hrs. with 2 SCADA interrogations per minute and 2 operation cycles of open-close-open of a disconnecting switch at the end of the first hour and close-open-close of a disconnecting switch at the end of the second hour.

Optional Modules
The device or object of the present invention can be equipped with any one of the following optional modules:
   i) Voltage Time Control Panel to carry out automatism of auto sectionalization in the Distribution of Average Tension Networks
   ii) Local Control Panel for local operation of up to four (4) disconnecting switches
   iii) Module for expansion of sixteen (16) optoisolated digital inputs
   iv) MODEM of low speed that operates under the standards of communication Bell202 or V.23
   v) Ethernet Net card 10/100/1000 T-base redundant
   vi) “Wireless” Net card
   vii) Wireless card for “Bluetooth” connection
   viii) Application of Firmware based on logics of detection of voltages in the Distribution of Average Tension Networks, denominated Control Voltage Time or CVT
   ix) Application of Firmware to handle the Local Control Panel
   x) Application of Firmware to handle measurement of Energy Quality
   xi) Harris 5000/6000 Slave Communication Protocol
   xii) DNP master and slave Communication protocol

The device of the present invention is conformed in its basic form, of four (4) modules:
I. Processing and Communications Module.
II. Analogical Processing Module.
III. Analogical Conditioning Module.
IV. Charge Source Module.

Processing and Communications Module

The Processing and Communications Module has the capability to acquire digital signals and execute opening and closed controls to control the disconnecting switch located in the line of average tension. It also controls the serial communication of up to two ports in a simultaneous way.

Internally, it has a power supply that operates with an input voltage that can go from 9 VDC up to 24 VDC, which makes it ideal for different applications where the feeding levels vary.

The internal Source of the Processing and Communications Module generates the voltages to feed their own circuits and the one in the slave cards that are interconnected to it, ±12 VDC, +5 VDC, +3.3 VDC and +5 VDC isolated.

It has the capacity to manage up to sixteen (16) Digital Inputs with capacity of external wet of 12 VDC, 24 VDC or 48 VDC, configurable in the factory according with necessities of the user, it has with common general for all the inputs. All the digital inputs are optoisolated, offering 1.5 KV of isolation, and are protected against transitions of up to ±5 Kv 5/50 ns, are protected against reverse polarization and offer protection against voltage overload of 200% of the nominal non constant.

The controls are executed with open contacts normally, with capacities of 28 VDC @ 10 Amp and 120 VDC @ 10 Amp. They include galvanic isolation of 1.5 KV of input-output and protection against transitory of up to ±5 Kv 5/50 ns in each one of the output banding posts. So to provide greater security the controls include a permissible switch named “Remote/Local” for execution of the controls which block the control execution in a local manner when it is in “Remote” position, providing with this, greater security to the maintenance personnel. This switch has a luminous blue color indicator in which it can be viewed when it is in the “Remote” position, reinforcing the security in the execution of controls during maintenance work.

The Processing and Communications Module physically includes three ports of communication of the serial type, configurable as RS232 or RS485 denominated COM1, COM2 and COM3, which are available by means of connectors standard RJ45, located in the positions J1, J2 and J3 of the module, these ports include visual indications of data activity and handle all the lines of flow control so that they are compatible with different communications equipment such as Radios or Modems. They handle a data transmission speed from 300 to 115200 baud. Both the speed of data transmission and the type of port are configurable by means of software.

Two of these ports, COM1 and COM2, are used for data communication by means of communication protocol and the other port COM3 is dedicated for equipment configuration and maintenance, Also it counts or operates with two communication ports of the serial type RS485. One of them, denominated COM4, is available by means of a connector type Terminal Block in position PP8 of the module. The purpose of this port is to make an external data communication network RS485 for the connection of external peripheral modules.

The other port of communication RS485 is available by means of a female socket for raised assembly which is located in the position P1. This connector is used to interconnect module bases or for expansion of the device.

It includes two Bus of internal parallel Data available by means of located connectors plugs located in positions PP9, PP10 and PP1 of the module and used for the interconnection of connectivity cards such as Ethernet network cards, “Wireless” net card, Bluetooth Wireless Connection card or MODEM.

It includes three Bus of internal parallel data available by means of female sockets for raised assembly located in positions PP4 and PP5 of the module, used to interconnect module bases or for expansion of the device.

All the ports are optoisolated and protected against transitory in the lines of communication.

For the processing of information, the Processing and Communications Module includes a 44 MHz microprocessor with 512 KB Flash memory used to store firmware and the configuration of the system. It also has 512 KB RAM memory that is used to store the events of the system operation. It also includes one back up battery to avoid RAM memory erasure in absence of current supply thus losing the stored events.

It includes a red indicator of switching on the module and a green indicator of operation of the microprocessor.

Analogical Processing Module

The Analogical Processing Module is constituted by a dedicated microprocessor type DSP (Digital Signal Processor), which is in charge of processing and calculating up to (15) analog channels with a frequency of 60 Hz.

The (15) analog channels are multiplexed to a single channel for their processing. The resulting channel is attenuated and filtrated with the purpose of eliminating undesirable signals.

Once the multiplex signal leaves the filtering, it is sent to a Digital Analog Circuit for its conversion, the conversion being made by means of an analog digital converter ADC of (13) bits plus sign. Once the conversion is made, said information is sent to the DSP for its processing.

The DSP is in charge of calculating all the variables of the Electrical Networks from a sinusoidal signal, such as voltages and flows RMS (Root Mean Square), of phase, of line, real and reactive powers, power factors, angles and harmonic distortion.

Values are reported to the Processing and Communications Module by means of a serial port RS485.

The Analogical Processing Module includes a serial port type RS485 available by means of a header type male connector identified as P1. This port includes optical isolation of 1.5 Kv and visual indicators for the lines of data communications. By means of this connector it is assembled to the Processing and Communications Module without the need to use cables.

In addition it includes another serial port type RS232 available through a Header connector identified as J1. This port is used for unloading or Firmware update without the need to disassemble the card.

The Analogical Processing Module has a red color visual indicator for switching on the module and a green color visual indicator for DSP operation.

The supply voltages of the Analogical Processing Module are ±12 VDC, +5 VDC, 3.3 VDC with respect to 0V and from +5 VDC isolated with respect to isolated 0 VDC, these voltages are taken from the Processing and Communications Module once the card is interconnected to this module.

Analogical Conditioning Module

The Analogical Conditioning Module is in charge of engaging signals from the field sensors to levels capable to be processed for its analysis. This module has the capability to acquire up to fifteen (15) analog channels of 60 Hz, configurable as tension or current channels depending on the user needs. The channels are adjusted in the factory, according to the sensor used by the user, independently if they are tension sensors, flow or flow-tension.

Conditioning of the voltage signals are made through the voltage splitters and operational amplifiers which provide the necessary gain to obtain the proper levels for their processing.

The conditioning of the flow signals is made by means of differential amplifiers, which registers the fall of tension of the monitoring resistances of flow, Shunts resistance of high precision which allows elimination of the conditioning transformers that typically are used by similar equipment and generate the necessary gain for its processing.

All the analogical channels are designed so that they have an input impedance of 1 MOhm to avoid an effect of load in the sensors and to avoid with this the distortion of the field signals.

The module includes a circuit of reference of +5 VDC, −5 VDC and 0 V with a thermal creep age of ±3 ppm. These references are delivered jointly with the analogical channels to the Analogical Processing Module for their processing.

Each one of the channels has the capability to support up to a 250% of the nominal constant value without any damage, regardless if it is a tension or current channel.

The supply voltage of the Analogical Preparation Module is ±12 VDC. This voltage is taken from the Processing and Communication Module once it is connected, by means of a socket type connector for raised assembly located at the positions Pi.

The conditioning card includes protection against transitory of up to ±5 Kv 5/50 ns.

Charge Source Module

The Charge Source is a power supply of the commutated type, of Flyback topology, which allows the consumption of input power to be reduced, making it more efficient. The Charge Source is in charge of providing the different types of supplying to the elements of the Acquisition and Control Device and, in addition, has the capability to supply the engine of the Relay switch located in the high tension lines of the Electrical Network.

It generates the output voltages 15 VDC @ 3 Amperes constant to manage the diverse circuits and the one of 24 VDC @ 10 Amperes non constant to supply the engine of the sectioned one. Internally it generates voltages to feed its electronics such as +5 VDC to feed its own microprocessor and +5 VDC isolated for the communication stage.

The rank of the input voltage that supports the Charge Source goes from 90 VAC to 146 VAC, includes two inputs for VAC supplying that are handled like primary and secondary for applications where there is redundancy in alternated supplying, and includes protection against transitory of up to ±5 Kv 5/50 ns.

The Charge Source also can be a feed of 24 VDC for applications where a battery pack is handled as back up supply in case of faults.

The commutation between the primary supply, back up supply of VAC, and back up supply with the battery pack, is made in “hot,” that is to say, that the change of supply in case of faults in the electrical supply will not affect the load. This is why this change will be transparent without alteration to the equipment that depend on the supply generated by the charge source. It has the capability to be manually switched on with Batteries without the need of unsafe connections.

The charge source is an intelligent device since it includes an 8 bits to 20 MHz microprocessor and a 10 bits ADC, this one being in charge of processing the different samples of signals for the different measurements that are taken from the charge source as well controlling the flow of the serial communication of the source towards the Processing and Communications Module, controlling the hardware to carry on the commutation between the primary supply input or secondary of alternate VAC, the commutation to Batteries when the two inputs of alternated VAC fail, and the execution of the battery test, and is in charge of determining the alarms and indicating them both by serial communication and by visual indication, and within its operation registers the battery load to determine and to apply the levels of equalization and flotation.

The communication that the charge source handles is serial through RS485 interface, by means of proprietary protocol where the different alarms and measurements are exploited as well as the start up operations and end of battery test from the Processing and Communications Module.

The charge source includes two chargers used to maintain a 24 VDC battery pack correctly loaded so that it is ready to operate in a contingency moment at the contingency time in the primary or secondary VAC supply, the chargers operating under the scheme of equalization and flotation level to achieve a correct load on the battery pack.

In addition, the charge source includes an RS485 serial port with a Terminal block type connector for communication with the Processing and Communications Module.

A function of the charge source is the measurement of ideal parameters of the system operation, diagnosis and maintenance, such as the levels and alarms. The levels include: the source output voltage; consumed flow of the source; and batteries level. All of these measurements may be reported via serial communication RS485 to the Processing and Communications Module.

The alarms are generated according with the operation parameter measurements such as: batteries test; VAC fault; low batteries level; voltage failure alarm of 13.8 VDC; and batteries failure. All of these alarms may be reported in a visual way by means of light-emitting diodes and by RS485 serial communication to the Processing and Communications Module.

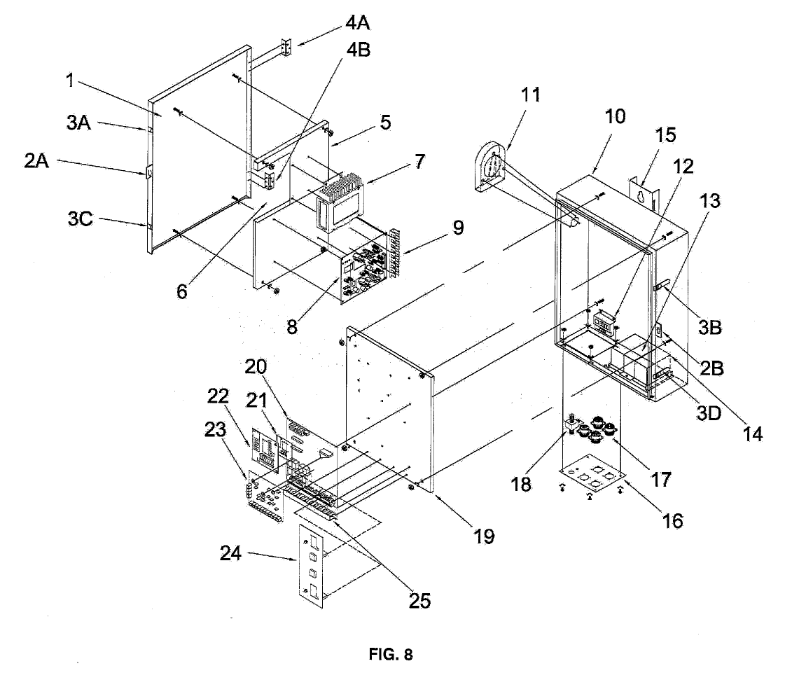

Referring now to FIG. 8 of the accompanying drawings, in which the following is shown:

A cabinet door 1, which is made of 14 caliber stainless steel polished with natural finish, has two stainless steel clap type locks and welded hooks identified by numbers 3A and 3C that are the counterpart that are used to assure the claps; to the door is also welded a counterpart hinge identified by numbers 4A and 4B and a counterpart of the ironwork padlock eye identified by number 2A.

The Door also has four (4) welded stainless steel spiral-shaped bolts which are used to fix an equipment tray identified by number 5 with a screw.

An equipment tray 4, made in 14 caliber aluminum plate with natural finish, is assembled in the cabinet door 1. The design of the tray as it is shown in the figure is of asymmetric form in such way that the upper part is greater than the bottom part. The intention with respect to the greater upper part is that, jointly with door 1, it will form a paper carrier space as it is indicated by number 6.

Likewise, in the upper part of the equipment tray 5, it has four aluminum bolts with inner thread inserted under pressure that are used for the assembly of a radio for data transmission identified by number 7. In the lower part, the equipment tray 5 has another four aluminum bolts with inner thread inserted under pressure that are used for the assembly of a Charge Source 8.

Into the equipment carrier a gutter 9 is placed with rivets and is used to guide the internal connection harness of the Acquisition Control and Measurement Device.

Into a cabinet body 10, which is made in 14 caliber stainless steel polished at natural finish, an air cleaner 11 is fixed by means of screws, as is a box with thermo magnetic switches 12. A battery pack 14 also is fixed into the cabinet body 10, using an “L” type ironwork marked with number 13.

Into the cabinet body 10, the counterparts of the hinge 3B and 3C are welded, as well as the counterpart of the padlock eye ironwork 2B.

The cabinet body 10 has welded into its back part, an ironwork for assembly in a post or in a wall, which is made of caliber 12 stainless steel plate. The ironwork is indicated in the figure with number 15.

The lower part of cabinet body 10 includes a 14 caliber detachable stainless steel cover, identified with number 16. The detachable cover is used to assemble the military type circular connectors for interconnection of external signals identified with number 17, and a suppressor of transitory for protection against atmospheric discharge of the radio's RF (Radio Frequency) line of transmission identified with number 18.

In the inner part, at the bottom of the cabinet body 10, four tread bolts of stainless steel are welded which are used to screw in or attach an equipment tray identified with the number 19.

The equipment tray 19 is made of 14 caliber aluminum, has aluminum bolts of inner thread inserted under pressure for the assembly of the modules of; i) Processing and Communications 20; ii) Processor 21; iii) Analogical Processing 22; iv) Analogical Preparation 23, and; v) the Local Control Panel (optional) identified with number 24.

Into the equipment tray 19 is also placed, with rivets in the lower section, a gutter 25 which is used to guide the internal connection harness of the Acquisition Control and Measurement Device.

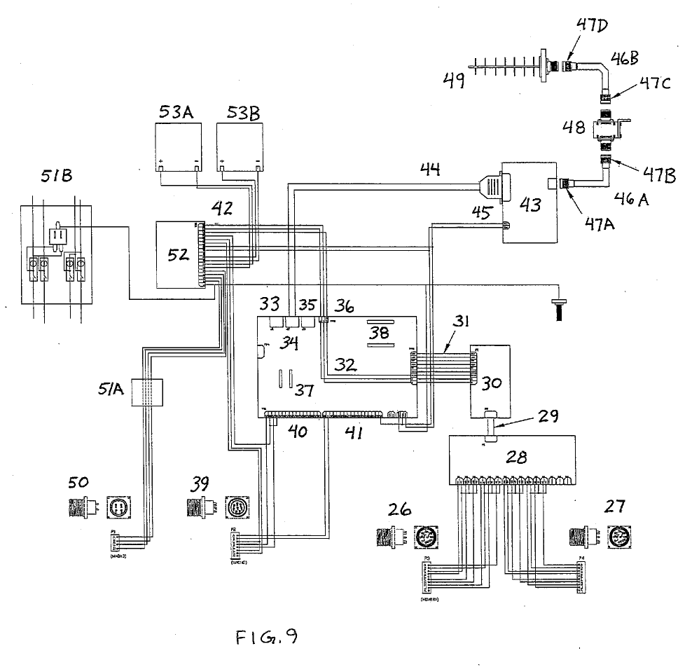

Referring now to FIG. 9 of the accompanying drawings, the superior and lateral views of military type circular connectors 26 and 27 are shown, which are used to interconnect the signals of the analogical voltage and flow from of the registering devices connected into the high tension cables into which the Acquisition Control and Measurement Device is interconnected to obtain voltage and flow signals that allow it to process readings of measurements, such as voltages and RMS (Root Mean Square) flow, of phase, of line, real and reactive powers, power factors, angles and harmonic distortion.

The input signals that are carried through connectors 26 and 27 into an Analogical Preparation Module 28 are conditioned on the Analogical Preparation Module 28 using Shunt resistances of high precision and circuits to upgrade the signal to voltage levels and flow suitable for processing, being able to tailor up to fifteen channels of analogical measurement of voltage or flow or both.

The Analogical Preparation Module 28 is interconnected to an Analogical Processing Module 30 without the need to use cables, by means of a Header type connector identified with number 29.

The tailored field signals are passed from the Analogical Preparation Module 28 to the Analogical Processing Module 30 through the Header type connector 29, which is a RS485 serial port.

The Analogical Processing Module 30 takes charge to process the signals of the fifteen analogical channels using a DSP microprocessor. The DSP takes charge to calculate all the variables of the Electrical Network from a sinusoidal signal, such as voltages and RMS (Root Mean Square) flow, of phase, of line, real and reactive powers, power factors, angles and harmonic distortion.

Values are reported to a Processing and Communications Module 32, by means of a Header type connector identified with number 31 which is an RS485. serial port.

Number 39 shows the upper and lateral side view of the military type circular connector used to interconnect the signals of the state of the relay switch located in the high tension cables of the electrical network. By means of this connector, the signals of the state of the gas pressure of the tank of the disconnecting switch and the state of the switch are obtained, such as whether it is open or closed, and are carried to the Processing and Communications Module 32 through a terminal block type connector of Digital Entrances identified by number 41 Likewise, the Processing and Communications Module 32 sends the signal to operate the relay switch (open or close) through a Terminal block type connector of Digital Exit 40.

Also, through the military type circular connector 39, 24 VDC is sent, which is voltage with which the engine is fed that operates the relay switch. This voltage is provided by a charge source 52, through the Terminal block type connectors 42.

The Processing and Communications Module 32 is in charge of processing the information delivered by the Analogical Processing Module 30 and the digital signals that the same one obtains from the field equipment, and sending them by means of communication protocol through the data port 34.

This module also includes another port for data communication RS232/RS485 identified by number 35 and includes a configuration and maintenance port RS232/RS485 identified by number 33.

For the connection of peripheral modules, it includes an RS485 port identified by number 36.

In order to place expansion cards of Digital Exits or Local Control Panel, Modem or Network card, the Processing and Communications Module 32 includes 2 ports with Terminal block type connectors 37 and 38.

Into a radio for data transmission 43, a cable of communication 44 is interconnected. This cable is interconnected to the RS232 data port of the radio and to the RS232 data ports 34 of the Processing and Communications Module 32. By means of this connection the data goes to radio 43 so that it is in charge of modulating them and sending them by the air to a Control Center using a yagui type directional antenna 49, which is connected into radio 43, through RF (Radio Frequency) transmission cables of low losses identified by numbers 46A and 46B and with a transitory suppressor 48 for protection of the RF (Radio Frequency) transmission line against atmospheric discharges.

The RF transmission cables 46A and 46B, include at their ends type N RF connectors, identified by numbers 47A, 47B, 47C and 47D, to create the joints of the connections of all the RF components.

The Radio 43 also takes its +15 VDC feeding voltage from a Charge Source 52 by means of a feeding cable 45 that runs from the terminal block connectors 42 of Charge Source 52 to the feeding input of the radio 43.

By number 50, the upper and lateral views of the military type circular connector are shown used to interconnect the 127 VAC main and back up feeding from the lines of the Electrical Network distribution.

Before the 127 VAC feeding is delivered into the Charge Source 52, it is passed through the thermo magnetic switches 51A and 51B, that serve to protect the equipment in case of a short-circuit in the 127 VAC line.

In this manner, the supply is taken into the Charge Source 52 from the thermo magnetic switches into the Terminal block connectors 42 of the Charge Source 52.

The Charge Source 52 is in charge of providing supply to the modules of: Processing and Communications 32; Analogical Processing 30; Analogical Preparation 28; Radio 18; and the engine relay switch, located in the high tension lines of the Electrical Network (not shown). It also feeds the optional modules when they are used in the integration of the Acquisition Control and Measurement Device (not shown).

The Charge Source 52 also includes the function of charging the 24 VDC battery pack formed by two Batteries 53A and 53B. This battery pack provides to the device a back up of up to: 8 hrs in “standby”; 6 hrs. with 2 SCADA interrogations per minute; 4 hrs. with 2 SCADA interrogations per minute and two cycles of opening-close-opening of a relay switch at the end; or 2 hours with 2 SCADA interrogations per minute and 2 cycles of opening-close-opening of a disconnecting switch at the end of the first hour and close-opening at the end of the second hour.

In lieu that several modifications can be made in our invention as it has been described, and many apparently ample materializations of the same can be made within the spirit and scope of the Claims without separating from such spirit and scope, it is intended that all the matter contained in the accompanying specification shall be interpreted as illustrative only and not in a limiting sense.

Being described the invention, we consider as new and therefore we claim the contents of the following:

1. An acquisition, control and measurement device that operates as an element of acquisition, control and measurement in an electrical distribution of average tension network or in an electrical substation, operating as master device or slave in SCADA systems, wherein said device processes logical states and analogical signals, and handles digital outputs using relay contacts and optoisolated digital inputs, said device comprising:
communication ports, connectivity and data management that allows said device to be used to simultaneously interconnect control equipment to diverse systems of acquisition via said communication ports and standard communication protocols;
a remote device that accesses a data base;
wherein said device manages SCADA protocols while also serving as a data concentrator and/or translator of communication protocols; and
a virtual connection of the transparent port type for communication towards other devices, wherein said other devices handle proprietary software without data conversion through any of said communication ports.

2. The device as claimed in claim 1, further comprising:
two VAC inputs that operate redundantly, thereby maintaining operation of said device in the absence of either of said VAC inputs;
a battery pack that enters into operation in the absence of said VAC inputs; and
an alarm that alerts, in a remote way via a communication protocol, the absence of either of said VAC inputs or a low level or damage condition of said battery pack.

3. The device as claimed in claim 2, wherein said VAC inputs comprise 127 VAC inputs.

4. The device as claimed in claim 1, further comprising functionalities management for measurement of energy quality, wherein said measurement is related to the measurement of electrical disturbances.

5. The device as claimed in claim 4, wherein said electrical disturbances comprise overtones or interruptions of voltage that can affect the electrical conditions of supply and cause malfunction or damage to equipments involved within the electrical network.

6. The device as claimed in claim 4, wherein said device accepts inputs of fifteen analogical signals of at least one chosen from 60 Hertz of flow or voltage proceeding from sensors located in high tension cables of an electrical network, wherein said inputs are tailored using high precision shunt resistances and optical conditioning.

7. The device as claimed in claim 1, wherein said device accepts inputs of fifteen analogical signals of at least one chosen from 60 Hertz of flow or voltage proceeding from sensors located in high tension cables of an electrical network, wherein said inputs are tailored using high precision shunt resistances and optical conditioning.

8. The device as claimed in claim 1, wherein said device detects a fault of flow overload in the line of average tension and to send an alarm towards a master central unit that is monitoring said device, wherein said master central unit analyzes provided information and isolates the fault and restores a failed section of the circuit of an electrical network remotely operating a relay switch.

9. The device as claimed in claim 1, wherein said device is operable to carry out automatism of auto sectionalization in the distribution network of average tension using operation logics denominated Control Voltage Time and special hardware, based on the detection of voltages as much from a source as from a load side, wherein said device, in the presence of a contingency or failure within a ringed circuit, isolates a failed section, restores healthy sections located between the source and the failed section and recovers later healthy sections through a liaison element toward the other circuit of the electrical distribution of average tension network.

10. The device as claimed in claim 1, wherein said device is equipped with basic elements of said device, to offer the possibility of expansion or growth of function by adding Firmware modules or embedded software and adding corresponding hardware modules in interconnection connectors whereby said expansion or growth of function occurs without the need to use cables.

11. The device as claimed in claim 1, wherein said logical states and analogical signals comprise at least one chosen from voltages and flow parameters RMS (Root Mean Square), of line phase, real and reactive powers, power factor, angles, harmonic distortion and measurement of energy quality.

12. The device as claimed in claim 1, wherein said access to said data base is through a connection comprising at least one chosen from TCP/IP, RS-232, RS-485, Modem GPRS, and Modem FSK via an available method comprising at least one chosen from radio, telephone, audio, cellular, Internet, Intranet or cable.

13. The device as claimed in claim 1, wherein said standard communication protocols comprise one chosen from DNP and Harris 5000/6000.
